(19) United States
(12) Patent Application Publication
(10) Pub. No.: US 2023/0401942 A1
(43) Pub. Date: Dec. 14, 2023

(54) Motion Detection System

(71) Applicant: AK Ingineering, Chicago, IL (US)

(72) Inventor: Arthur Kucharski, Chicago, IL (US)

(21) Appl. No.: 18/207,948

(22) Filed: Jun. 9, 2023

Related U.S. Application Data
(60) Provisional application No. 63/366,185, filed on Jun. 10, 2022.

(51) Int. Cl. G08B 13/14

(52) U.S. Cl. CPC G08B 13/1436; G08B 13/1472

(57) ABSTRACT

A method performed by a sensor device includes detecting a motion of the sensor device and transmitting a notification of the motion. A method performed by a control device includes receiving, from the sensor device, a notification of a motion of the sensor device, and generating, via a user interface, an indication of the motion of the sensor device.

### CROSS REFERENCE TO RELATED APPLICATION

The present application claims priority to U.S. provisional application No. 63/366,185, filed Jun. 10, 2022, the entire contents of which are hereby incorporated by reference.

### FIELD

The present disclosure generally relates to motion detection systems, and more specifically to motion detection systems that include a sensor device and a control device.

### BACKGROUND

Theft of expensive trailer-hauled equipment such as skid loaders can be a problem in some situations. More convenient and reliable anti-theft systems are needed.

### SUMMARY

One aspect of the disclosure is a method performed by a sensor device, the method comprising: detecting a motion of the sensor device; and transmitting a notification of the motion.

Another aspect of the disclosure is a non-transitory computer readable medium storing instructions that, when executed by a sensor device, cause the sensor device to perform functions comprising: detecting a motion of the sensor device; and transmitting a notification of the motion.

Another aspect of the disclosure is a sensor device comprising: one or more processors; a motion sensor; a communication interface; and a computer readable medium storing instructions that, when executed by the one or more processors, cause the sensor device to perform functions comprising: detecting a motion of the sensor device via the motion sensor; and transmitting a notification of the motion via the communication interface.

Another aspect of the disclosure is a method performed by a control device, the method comprising: receiving, from a sensor device, a notification of a motion of the sensor device; and generating, via a user interface, an indication of the motion of the sensor device.

Another aspect of the disclosure is a non-transitory computer readable medium storing instructions that, when executed by a control device, cause the control device to perform functions comprising: receiving, from a sensor device, a notification of a motion of the sensor device; and generating, via a user interface, an indication of the motion of the sensor device.

Another aspect of the disclosure is a control device comprising: one or more processors; a global positioning system (GPS) receiver; a user interface; a communication interface; and a computer readable medium storing instructions that, when executed by the one or more processors, cause the control device to perform functions comprising: receiving, from a sensor device, a notification of a motion of the sensor device; and generating, via a user interface, an indication of the motion of the sensor device.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The features, functions, and advantages that have been discussed can be achieved independently in various examples or may be combined in yet other examples further details of which can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 is a block diagram of a sensor device and a control device, according to an example.

FIG. 2 is a schematic diagram of a sensor device and a control device, according to an example.

FIG. 3 is a block diagram of a method, according to an example.

FIG. 4 is a block diagram of a method, according to an example.

### DETAILED DESCRIPTION

Disclosed examples will now be described more fully hereinafter with reference to the accompanying Drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

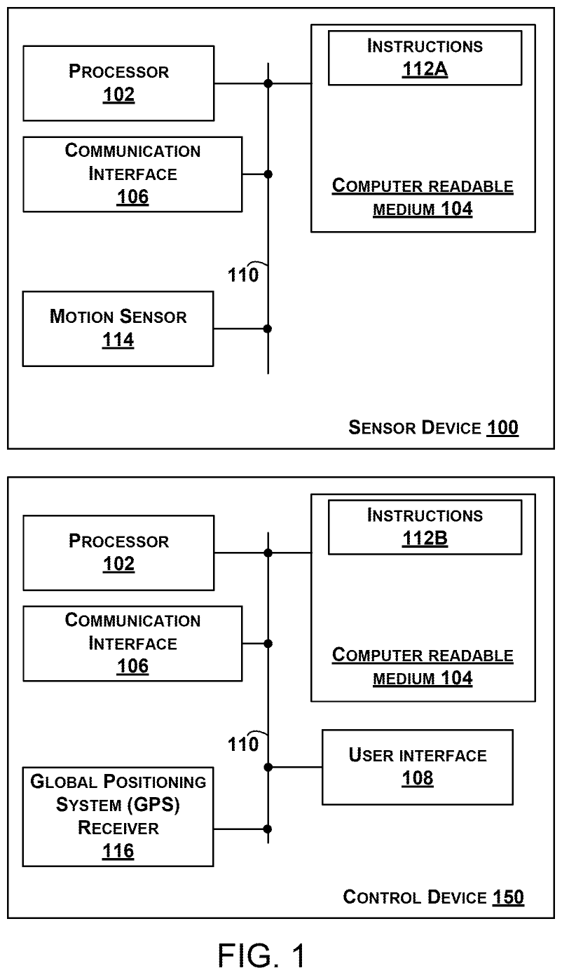

FIG. 1 is a block diagram of a sensor device 100 and a control device 150.

The sensor device 100 includes one or more processors 102, a non-transitory computer readable medium 104, a communication interface 106, and a motion sensor 114. Components of the sensor device 100 are linked together by a system bus, network, or other connection mechanism 110.

The one or more processors 102 can be any type of processor(s), such as a microprocessor, a field programmable gate array, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 104 can store instructions 112A. The instructions 112A are executable by the one or more processors 102 to cause the sensor device 100 to perform any of the functions or methods described herein.

The communication interface 106 can include hardware to enable communication within the sensor device 100 and/or between the sensor device 100 and one or more other devices. The hardware can include any type of input and/or output interfaces, a universal serial bus (USB), PCI Express, transmitters, receivers, and antennas, for example. The communication interface 106 can be configured to facilitate communication with one or more other devices, in accordance with one or more wired or wireless communication protocols. For example, the communication interface 106 can be configured to facilitate wireless data communication for the sensor device 100 according to one or more wireless communication standards, such as one or more Institute of Electrical and Electronics Engineers (IEEE) 801.11 standards, ZigBee standards, Bluetooth™ standards, etc. As another example, the communication interface 106 can be configured to facilitate wired data communication with one or more other devices. The communication interface 106 can also include analog-to-digital converters (ADCs) or digital-to-analog converters (DACs) that the sensor device 100 can use to control various components of the sensor device 100 or external devices.

The motion sensor 114 can the take the form of an accelerometer or any other transducer that can generate an analog or digital signal that represents a quantification of acceleration and/or velocity of the sensor device 100.

The control device 150 (e.g., a smart phone) also includes instances of the one or more processors 102, the non-transitory computer readable medium 104, the communication interface 106, and the connection mechanism 110. The non-transitory computer readable medium 104 can store instructions 112B. The instructions 112B are executable by the one or more processors 102 to cause the control device 150 to perform any of the functions or methods described herein.

The control device 150 also includes a user interface 108 and a global positioning system (GPS) receiver 116.

The user interface 108 can include any type of display component configured to display data. As one example, the user interface 108 can include a touchscreen display. As another example, the user interface 108 can include a flat-panel display, such as a liquid-crystal display (LCD) or a light-emitting diode (LED) display. The user interface 108 can include one or more pieces of hardware used to provide data and control signals to the sensor device 100. For instance, the user interface 108 can include a mouse or a pointing device, a keyboard or a keypad, a microphone, a touchpad, or a touchscreen, among other possible types of user input devices. Generally, the user interface 108 can enable an operator to interact with a graphical user interface (GUI) provided by the sensor device 100 (e.g., displayed by the user interface 108).

The GPS receiver 116 is configured to receive signals from multiple satellites and use the signals to calculate a geolocation of the control device 150. The signals include orbital parameters and time stamps. The GPS receiver 116 uses the travel time of the signals from multiple satellites to triangulate the geolocation of the control device 150.

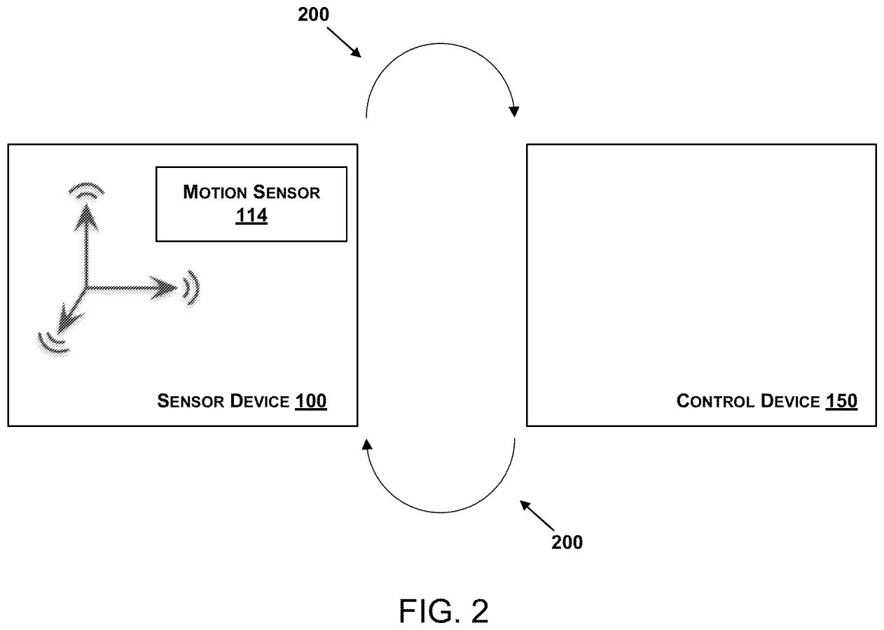

FIG. 2 is a schematic diagram of the sensor device 100 and the control device 150. In an example, the sensor device 100 is attached to a ratchet strap that is holding a piece of heavy equipment such as a skid loader to a trailer, or attached to the heavy equipment itself. For instance, straps with hook-and-loop fasteners are used to attach the sensor device 100 to the ratchet strap or to the heavy equipment. In other examples, zip-ties, screws, a plastic clip integrated with the sensor housing, or double sided tape could be used to attach the sensor device 100 to the ratchet strap, a bungee cord, or to the heavy equipment, such as a skid loader, an all-terrain vehicle, or a ladder. If an unauthorized user attempts to tamper with and/or move the ratchet straps or the heavy equipment, the sensor device 100 will be disturbed by experiencing an accelerative force, and the sensor device 100 will responsively transmit a notification to the control device 150.

Thus, the sensor device 100 detects a motion (e.g., an acceleration) of the sensor device 100 using the motion sensor 114. Next, the sensor device 100 transmits a notification via a wireless communication channel 200 (e.g., a Bluetooth™ connection, a peer-to-peer IEEE) 801.11 connection or an IEEE 801.11 connection by way of a router or a server) to the control device 150. In some examples, the sensor device 100 transmits to the control device 150 a notification indicating when (e.g., a time and/or a date) the motion occurred. In any example of this disclosure, communication between the sensor device 100 and the control device 150 can take place via the wireless communication channel 200.

In particular, the sensor device 100 can use the motion sensor 114 to determine that the sensor device 100 absorbed a force that exceeds a force threshold to detect the motion of the sensor device 100. In some examples, the sensor device 100 receives information, via the wireless communication channel 200 from the control device 150, defining the force threshold and uses the force threshold defined by the information to determine that the motion of the sensor device 100 occurred. The force threshold could be +/−3 g, for example, where g=9.8 m/s².

In some examples, the sensor device 100 receives from the control device 150 a command to begin monitoring movement of the sensor device 100 (e.g., a command for the sensor device 100 to arm itself). As such, the sensor device 100 detects the motion of the sensor device 100 in response to receiving the command, due to being armed.

In a similar fashion, the sensor device 100 receives from the control device 150 a command to discontinue monitoring movement of the sensor device 100. As such, the sensor device 100 discontinues monitoring the movement of the sensor device 100 in response to receiving the command, due to being disarmed.

The control device 150 receives from the sensor device 100, the notification of the motion of the sensor device 100 and responsively generates, via the user interface 108, an indication of the motion of the sensor device 100. The indication could take the form of an audible alert or a pop-up notification, for example. In some examples, the indication indicates a time and/or date at which the motion occurred.

In some examples, the control device 150 determines a geolocation of the control device 150 using the GPS receiver 116 and transmits a request to a server for the wind speed at the geolocation of the control device 150. The control device 150 receives from the server information regarding the wind speed and determines a value for the force threshold based on the wind speed. Next, the control device 150 transmits the value for the force threshold to the sensor device 100. For example, during high wind conditions, the control device 150 might set a high value for the force threshold so that the sensor device 100 does not mistake high winds for a tamper attempt. The control device 150 can add a force threshold offset, e.g., 0.01 g, for every 1 mph of wind speed, for example. The relationship between wind speed and the force threshold can be linear or non-linear.

In another example, monitoring can be disarmed in situations where the user is sitting in a cab of a truck while towing the trailer. For example, the control device 150 determines that the control device 150 is moving at a rate of speed that does not exceed a threshold (e.g., less than 10 miles per hour (mph)) and that the control device 150 has maintained this speed for at least a threshold duration (e.g., 5 minutes). In response, the sensor device 100 is armed and/or the control device 150 is configured to generate a notification when motion is indicated by the sensor device 100.

In a similar fashion, the control device 150 can also determine that the control device 150 is moving at a rate of speed that does exceed the speed threshold (e.g., greater than 10 mph) and responsively disarm monitoring by the sensor device 100 and/or configure the control device 150 to ignore motion warnings from the sensor device 100. In some examples, the control device 150 can use the user interface 108 to generate an indication that the motion detection has been disarmed.

In some examples, the control device 150 determines that a communication session between the control device 150 and the sensor device 100 has ended or been interrupted. In response the control device 150 uses the user interface 108 to generate an indication that the communication session ended. The indication can also indicate a time at which the communication session between the control device 150 and the sensor device 100 has ended or been interrupted.

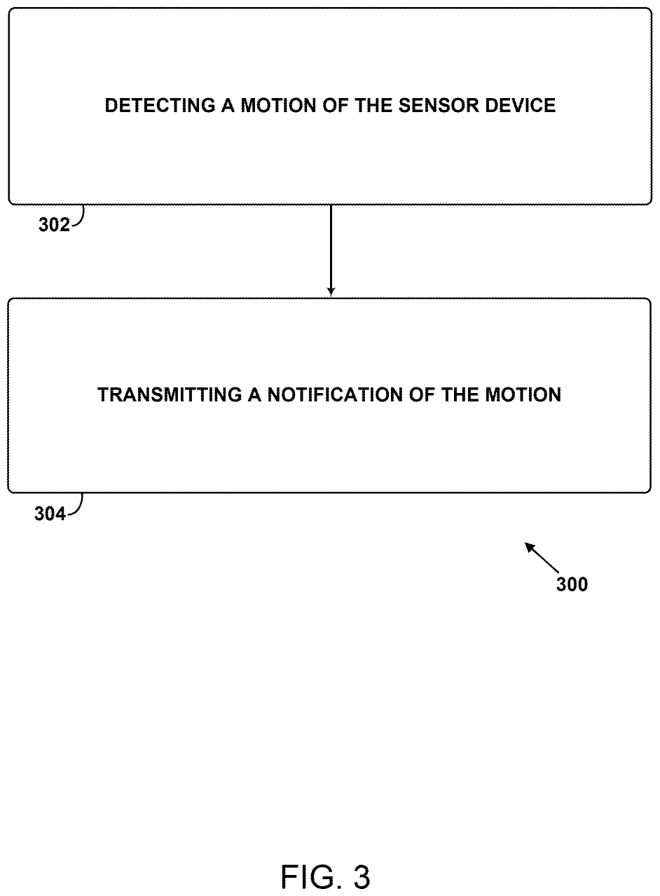

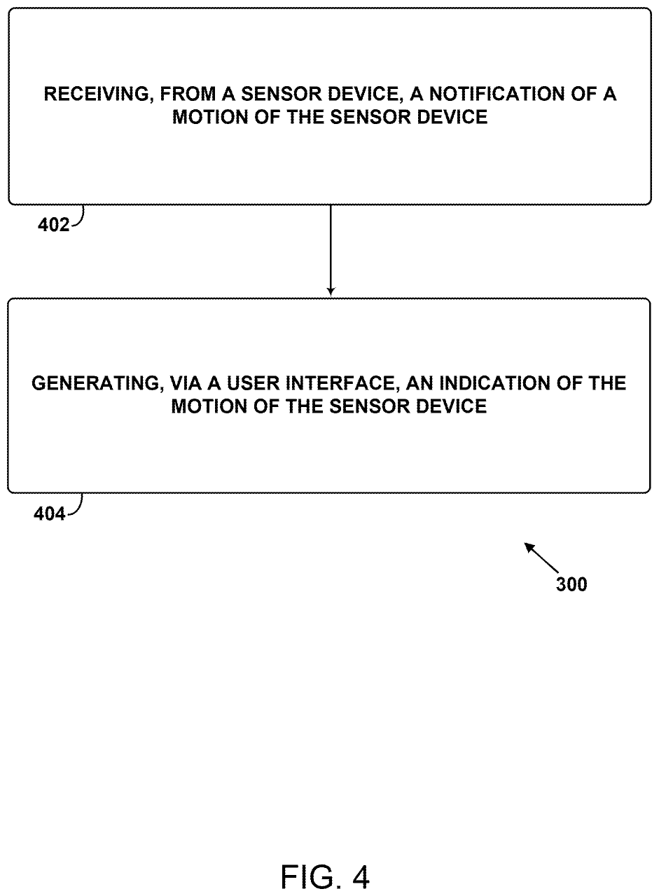

FIG. 3 and FIG. 4 are block diagrams of a method 300 and a method 400. As shown in FIG. 3 and FIG. 4, the method 300 and the method 400 include one or more operations, functions, or actions as illustrated by blocks 302, 304, 402, and 404. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes the sensor device 100 detecting the motion of the sensor device 100. This functionality is described above with reference to FIG. 2.

At block 304, the method 300 includes the sensor device 100 transmitting the notification of the motion (e.g., to the control device 150). This functionality is described above with reference to FIG. 2.

At block 402, the method 400 includes the control device 150 receiving, from the sensor device 100, the notification of the motion of the sensor device 100. This functionality is described above with reference to FIG. 2.

At block 404, the method 400 includes the control device 150 generating, via the user interface 108, the indication of the motion of the sensor device 100. This functionality is described above with reference to FIG. 2.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A method performed by a sensor device, the method comprising:
detecting a motion of the sensor device; and
transmitting a notification of the motion.

2. The method of claim 1, wherein transmitting the notification comprises transmitting the notification via a Bluetooth™ connection or an IEEE 801.11 connection.

3. The method of claim 1, wherein detecting the motion comprises determining that the sensor device absorbed a force that exceeds a force threshold.

4. The method of claim 3, further comprising:
receiving, from a control device, information defining the force threshold;
wherein determining that the sensor device absorbed the force that exceeds the force threshold comprises determining that the force exceeds the force threshold as defined by the information.

5. The method of claim 4, wherein receiving the information comprises receiving the information via a Bluetooth™ connection or an IEEE 801.11 connection.

6. The method of claim 1, wherein detecting the motion comprises detecting the motion via an accelerometer of the sensor device.

7. The method of claim 1, further comprising:
receiving, from a control device, a command to begin monitoring movement of the sensor device,
wherein detecting the motion comprises detecting the motion in response to receiving the command.

8. The method of claim 1, further comprising:
receiving, from a control device, a command to discontinue monitoring movement of the sensor device; and
discontinuing monitoring the movement of the sensor device in response to receiving the command.

9. The method of claim 7, wherein receiving the command comprises receiving the command via a Bluetooth™ connection or an IEEE 801.11 connection.

10. The method of claim 1, wherein transmitting the notification comprises transmitting a time stamp indicating when the motion occurred.

11. A method performed by a control device, the method comprising:
receiving, from a sensor device, a notification of a motion of the sensor device; and
generating, via a user interface, an indication of the motion of the sensor device.

12. The method of claim 11, wherein receiving the notification comprises receiving the notification via a Bluetooth™ connection or an IEEE 801.11 connection.

13. The method of claim 11, further comprising:
receiving information regarding a wind speed at a geolocation of the control device;
determining a value for a force threshold based on the wind speed; and
transmitting, to the sensor device, the value for the force threshold.

14. The method of claim 13, further comprising:
determining the geolocation of the control device; and
transmitting a request for the wind speed at the geolocation of the control device,
wherein receiving the information comprises receiving the information subsequent to transmitting the request.

15. The method of claim 11, further comprising:
making a determination that the control device is not moving at a rate of speed that exceeds a speed threshold,
wherein generating the indication comprises generating the indication in response to making the determination.

16. The method of claim 15, further comprising:
making a second determination that the control device is moving at a rate of speed that exceeds the speed threshold; and
generating an indication that the control device is not monitoring movement of the sensor device due to the rate of speed of the control device.

17. The method of claim 11, wherein receiving the notification comprises receiving a time stamp indicating when the motion occurred, and wherein generating the indication comprises generating the indication such that the indication indicates when the motion occurred.

18. The method of claim 11, further comprising:
determining that a communication session between the control device and the sensor device has ended; and
generating a second indication that the communication session ended.

19. The method of claim 18, wherein generating the second indication comprises generating the second indication such that the second indication indicates when the communication session ended.

20. A control device comprising:
one or more processors;
a global positioning system (GPS) receiver;
a user interface;
a communication interface; and
a computer readable medium storing instructions that, when executed by the one or more processors, cause the control device to perform functions comprising:
receiving, from a sensor device, a notification of a motion of the sensor device; and
generating, via a user interface, an indication of the motion of the sensor device.
